(19) United States
(12) Patent Application Publication
(10) Pub. No.: US 2003/0165764 A1
(43) Pub. Date: Sep. 4, 2003

(54) Toner for electrophotography

(76) Inventors: Yoshihito Suwa, Shimada-shi (JP); Hisashi Okuyama, Nishikamo-gun (JP); Yasumasa Horibe, Aichi-gun (JP)

Correspondence Address: NIXON & VANDERHYE, PC, 1100 N GLEBE ROAD, 8TH FLOOR, ARLINGTON, VA, 22201-4714, US

(21) Appl. No.: 10/368,340

(22) Filed: Feb. 20, 2003

(30) Foreign Application Priority Data
Feb. 22, 2002 (JP) P2002-047042

(51) Int. Cl. G03G 9/087

(52) U.S. Cl. 430/109.4; 430/108.4; 430/108.8

(57) ABSTRACT

The toner for electrophotography includes a polylactic acid type resin, a terpene-phenol copolymer, and at least one kind of wax. A melting point of at least one kind of the wax is equal to or less than a softening temperature of the terpene-phenol copolymer. It is preferable that a molar fraction of one of L-lactic acid unit and D-lactic acid unit with respect to a total lactic acid unit in the polylactic acid type resin is in the range between about 85 mol % and about 100 mol %. Also, it is preferable that the total amount of the wax in the toner is in the range between about 7-20% by weight with respect to toner particles.

### BACKGROUND OF THE INVENTION

1. Field of the Invention

The present invention relates to a toner for electrophotography. More specifically, the present invention relates to a toner for electrophotography, which corresponds to an oilless fixing system, having excellent low temperature fixing property, durability, etc., and a full color image of high quality and high gloss can be obtained using the toner. Also, the present invention relates to the toner for electrophotography considered about environmental and safety problems.

2. Description of Related Art

Recently, a fixing system for toner used in copying machines and printers which utilize an electrophotography system has been remarkably improved. For example, a low temperature fixing system has been developed to be used in monochrome copying machines and printers for the purposes of reducing energy consumption and improving printing speed.

Also, for copying machines and printers for full color printing, in particular, an oilless fixing system has been developed which does not use releasing agents or oils for its fixing device in order to simplify maintenance, save resources, decrease cost, and enhance image quality. That is, oil having excellent releasing property, such as silicone oil, is generally applied to a fixing roll used in conventional copying machines and printers to prevent a so called“offset” in which toner adheres and deposits on a fixing member, such as a fixing roll. However, in order to apply oil, an oil tank and an oil application device are required, and hence, the size of the copying machines and printers is increased, and they become complicated. Also, the fixing roll is deteriorated by the application of oil and maintenance operation for the fixing roll needs to be carried out for every certain time period. Moreover, it is inevitable that oil adheres to copying paper, overhead projector (OHP) film, etc. In particular, oil adhering to an OHP can cause significant problems, such as deterioration of color in OHP.

Also, in the new fixing system mentioned above, well-organized temperature control becomes necessary in order to fix the toner. Moreover, properties that match a particular fixing system are required for the toner used.

Furthermore, demands for full color image of high gloss similar to that of a picture are high, and toners for full color printing from which a smooth toner surface and high transparency are obtained after fixing are required to meet the demands.

In addition, toners recovered from copying machines and printers are usually discarded to be incinerated or landfilled. Also, it is difficult to deink the copied paper on which conventional toner is fixed, and hence, it is not an easy task to reutilize the copied paper for recycle. Recently, as concerns for environmental problems increase, demands for toner which does not cause environmental pollution if discarded and whose deinking from copied paper can be easily performed to recycle copied paper have been increased. Also, in conventional toners, there is a problem of volatile gases generated during a thermal fixing process of the toner, and hence, demands for toners which do not generate volatile gases and are not hazardous to humans are increasing.

In order to meet the above-mentioned number of requirements, various improvements have been achieved on toners for electrophotography.

First, in order to make toners for electrophotography correspond to a low temperature fixing system, molecular weight distribution of styrene-acryl resin or polyester resin, which are binder resins, has been changed to secure a wide range of non-offset temperature.

However, if the styrene-acryl resin or polyester resin is designed for the purpose of further improving its low temperature fixing property, anti-fusing property, durability, etc., of the resin are lowered instead, and the toner cannot exert sufficient performance thereof. Accordingly, it becomes necessary to contrive an amount of additives, a typical example of which is hydrophobic silica, and an addition method thereof.

Also, in order to make toners for electrophotography correspond to an oilless fixing system, methods are generally adopted to complement the performance of releasing oil, in which a large amount of releasing agents, such as wax, is added in toner particles, or the melt modules of elasticity (melt viscosity) of a binder resin is increased by cross-linking or by adding components of high molecular weight.

However, in copying machines and printers using an oilless fixing system in which a large amount of releasing agent added type toner is adopted, problems of inferior image characteristic tend to be caused by, for instance, the generation of black spots (BS) due to filming of toner to a photosensitive member during continuous copying of large number of sheets, or the fusing of toner to developing members, such as a developing roller and a layer thickness control member, or a charging member.

On the other hand, if the amount of wax added in toner particles is controlled, if the molecular weight distribution of a binder resin is extended, or if the melt viscosity is increased by cross-linking the binder resin, the smoothness of a image surface is decreased due to uneven melting state of the binder resin at a fixing temperature. Accordingly, critical problems for full color toners for electrophotography are generated, such as lowering of the gloss of an image and of the light transparency of an image on an OHP film.

Also, in order to obtain a full color image of high gloss, it is required that the surface of toner after fixing becomes smooth and that the transparency of each toner is high. In order to satisfy the requirements, it is necessary that the viscosity of the toner becomes significantly small at the fixing temperature of the toner. In order to lower the viscosity of the toner at the fixing temperature thereof to a significantly low level, it is necessary to decrease the molecular weight of the binder resin.

However, if only the molecular weight of the binder resin is decreased, the durability of the toner in a developing device is decreased. Accordingly, problems are caused, such as the generation of band-like uneven images, the background fogging of the toner at an early stage, and a toner offset at a fixing part.

Also, high image quality equal to that of a silver halide photography is required for a full color image, that is excellent gloss, color mixing property, and transparency. Accordingly, a polyester resin whose melt viscosity is relatively low is generally used as a binder resin for toner. Moreover, waxes are finely dispersed in toner particles in an amount that does not cause an offset, BS on a photosensitive member, and fusing to a developing members.

However, the range of amount of wax that can solve the above mentioned problems is narrow, and the determination of the range is not an easy task. Accordingly, natural waxes or polar waxes are generally used so that the wax is finely dispersed even if a larger amount of wax is added to the toner particles.

However, a polyester resin is intrinsically inferior to environmental resistance, and it is difficult to obtain a stable charging amount with respect to environmental changes, such as changes in temperature and humidity. Accordingly, the background fogging of the toner tends to be worsened at high temperatures and high humidity, and the image density tends to be decreased at low temperatures and low humidity. In addition, use of the natural waxes and polar waxes have further worsened the environmental resistance.

Japanese Unexamined Patent Application, First Publication No. Hei 7-120975 discloses a toner for electrophotography using polylactic acid type resin, as a toner which is environment-friendly and safe to human body. Moreover, Japanese Unexamined Patent Application, First Publication No. 2001-166537 proposes a toner for electrophotography which uses polylactic acid type resin and terpene-phenol copolymer resin as a main binder resin in order to improve a low temperature fixing property, an anti-offset property, and an anti-filming property with respect to a photosensitive member, a charging member, etc. However, as for the toner proposed in Japanese Unexamined Patent Application, First Publication No. 2001-166537, although a satisfactory low temperature fixing property in a state of retaining a wide non-offset range can be acquired, correspondence to an oilless fixing system and studies on obtaining full-color image of high gloss are not sufficient.

### SUMMARY OF THE INVENTION

Accordingly, an object of the present invention is to provide a toner for electrophotography, which is eco-friendly and safe to human body, is capable of maintaining sufficient image density, etc., for a long period of time under any environmental conditions including a continuous copying process, retains a non-offset temperature ranges of practically applicable level, does not generate BS on a photosensitive member or fusing to developing members, has excellent low temperature fixing property and durability, exerts gloss, color mixing property, and transparency sufficient for a full-color image (i.e., high image qualities same as those of a silver halide photography), is capable of forming an image having sufficient optical transparency when used for an OHP film, and which corresponds to an oilless fixing system.

Here, the term “non-offset temperature ranges of practically applicable level” means a temperature equal to or higher than 40° C. taking into account a temperature control performance of a fixing device and environmental changes.

The toner for electrophotography according to an embodiment of the present invention includes a polylactic acid type resin; a terpene-phenol copolymer; and at least one kind of wax, and a melting point of at least one kind of the wax is equal to or less than a softening temperature of the terpene-phenol copolymer.

In another aspect of the present invention, the polylactic acid type resin of the toner has a biodegradable property.

In yet another aspect of the present invention, a molar fraction of one of L-lactic acid unit and D-lactic acid unit with respect to a total lactic acid unit in the polylactic acid type resin is in the range between about 85 mol % and about 100 mol %.

In yet another aspect of the present invention, a total amount of the wax in the toner is in the range between about 7-20% by weight with respect to toner particles.

In yet another aspect of the present invention, it is preferable that the terpene-phenol copolymer of the toner includes at least one composition selected from the group consisting of: (a) cyclic terpene-phenol copolymer, prepared by copolymerizing cyclic terpene and phenol; (b) cyclic terpene/phenol (1:2 molar ratio) addition product, prepared by adding two molecules of phenol to one molecule of cyclic terpene; (c) polycyclic terpene/phenol (1:2 molar ratio) addition product, prepared by a condensation reaction of a cyclic terpene/phenol (1:2 molar ratio) addition product with aldehydes and ketones; and (d) polycyclic terpene/phenol (1:1 molar ratio) addition product, prepared by a condensation reaction of a cyclic terpene/phenol (1:1 molar ratio) addition product with one of aldehydes and ketones.

In yet another aspect of the present invention, it is preferable that the weight ratio of the polylactic acid type resin to the terpene-phenol copolymer resin is in the range between about 80:20 and 20:80.

In yet another aspect of the present invention, it is preferable that at least one kind of the wax includes lactide as its component.

In yet another aspect of the present invention, it is preferable that the toner is a toner for full-color printing corresponding to an oilless fixing system.

In yet another aspect of the present invention, it is preferable that the polylactic acid type resin has a structure expressed by the following formula (I);

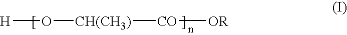

where R is an alkyl group having 1-24, preferably 1-12, and more preferably 1-5, carbon atoms, an alkali metal or an alkali earth metal, and n is an integer between 10 and 20,000.

### DETAILED DESCRIPTION OF THE INVENTION

The invention summarized above and defined by the enumerated claims may be better understood by referring to the following detailed description. This detailed description of particular preferred embodiments, set out below to enable one to build and use particular implementation of the invention, is not intended to limit the enumerated claims, but to serve as particular examples thereof.

Hereinafter the toner for electrophotography according to the present invention will be described in detail.

Polylactic acid type resin contained in the toner for electrophotography (hereinafter may also simply called as toner) according to an embodiment of the present invention mainly consists of lactic acid components, and includes a polylactic acid homopolymer, a lactic acid copolymer and a blend polymer thereof. The weight average molecular weight of the polylactic acid type resin is generally between 50,000 and 500,000.

Also, in order to obtain a toner having excellent fixing strength, and thermal flowability at low temperature range, it is preferable that the polylactic acid type polymer includes one of the L-lactic acid units and the D-lactic acid units as a main component, i.e., it is preferable that the polylactic acid type resin includes 85 mol %-100 mol % of one of the L-lactic acid units and the D-lactic acid units with respect to the entire lactic acid units. More preferably, the range of one of the L-lactic acid units or the D-lactic acid units is in the range between 90 mol % and 100 mol %. If the amount of the lactic acid units is lower than the above-mentioned range, the state of the polylactic acid type resin approaches to an amorphous state, and the fixing strength of a toner obtained tends to be lowered.

Moreover, from the viewpoint of stability (anti-hydrolysis property) as a toner used under environmental condition of high temperature and high humidity, it is preferable that the polylactic acid type resin has a chemical structure of the following formula (I):

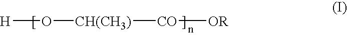

where R is an alkyl group having 1-24, preferably 1-12, and more preferably 1-5, carbon atoms, an alkali metal or an alkali earth metal, and n is an integer between 10 and 20,000. If the number of carbon atoms exceeds 24, it becomes difficult to prepare the polylactic acid type resin.

Lactic acid copolymer may be prepared by copolymerizing a lactic acid monomer or a lactide with other copolymerizable components. Examples of such copolymerizable components include dicarboxylic acids, polyalcohols, hydroxy carboxylic acids, lactones, etc., having more than two functional groups which may form an ester bonding, and various polyesters, polyethers, and polycarbonates having these components.

Examples of the dicarboxylic acids include succinic acid, adipic acid, azelaic acid, sebacic acid, telephthalic acid, and isophthalic acid.

Examples of the polyalcohols include aromatic polyalcohols prepared by such methods as an addition reaction of ethylene oxide to bisphenol, aliphatic polyalcohols such as ethylene glycol, propylene glycol, butanediol, hexanediol, octanediol, glycerin, sorbitol, trimethylol propane, and neo-pentyl glycol, and ether glycols such as diethylene glycol, triethylene glycol, polyethylene glycol, and polypropylene glycol.

Examples of the hydroxy carboxylic acids include glycol acid, hydroxy butyl carboxylic acid and acids described in Japanese Unexamined Patent Application, First Publication No. 6-184417.

Examples of lactones include glycoride, ε-caprolactone glycoride, ε-caprolactone, β-propiolactone, δ-butyrolactone, β- or γ-butyrolactone, pivarolactone, and δ-valerolactone.

The polylactic acid type resin may be prepared by using conventional methods. That is, it may be synthesized by a dehydration and condensation reaction of lactic acid monomers or a ring-opening polymerization of lactide which is cyclic dimer of lactic acid as described in Japanese Unexamined Patent Application, First Publication No. 7-33861, Japanese Unexamined Patent Application, First Publication No. 59-96123, and Koubunshi Touronkai Yokousyu (Debate for Polymers Proceedings) Vol. 44, pp. 3198-3199.

In the dehydration and condensation process, any one of L-lactic acid, D-lactic acid, DL-lactic acid, and a mixture thereof may be used. Also, when the ring-opening polymerization reaction is carried out, any one of L-lactide, D-lactide, DL-lactide, and a mixture thereof may be employed.

Processes for synthesizing, purifying, and polymerizing lactides are described in, for instance, U.S. Pat. No. 4,057, 537, EP Application No. 261, 572, Polymer Bullein, vol. 14, pp. 491-495 (1985), and Makromol Chem., vol. 187, pp. 1611-1628 (1986).

The catalysts which may be used in the above polymerization reaction are not particularly limited and known catalysts generally used for lactic acid polymerization may be utilized. Examples of such catalysts include, for instance, tin compounds such as tin lactate, tin tartrate, tin dicaprylate, tin dilaurylate, tin dipalmitate, tin distearate, tin dioleate, α-tin naphthoate, β-tin naphthoate, and tin octylate; tin powder, and tin oxide; zinc powder, halogenized zinc, zinc oxide, and organic zinc compounds, titanium compounds such as tetra-propyl titanate, zirconium compounds such as zirconium isopropoxide, antimony compounds such as antimony oxide, bismuth compounds such as bismuth oxide (III), and aluminum compounds such as aluminum oxide and aluminum isopropoxide.

Among the above catalysts, interalia, tin and tin compounds are preferable in terms of their activity. The amount of the catalysts used, for instance, in the open-ring polymerization reaction, is in the range between about 0.001 and about 5% by weight with respect to lactide.

In general, depending on the type of the catalyst used, the polymerization reaction may be carried out at a temperature in the range between about 100 and 220° C. Also, it is preferable to perform two-step polymerization as disclosed in Japanese Unexamined Patent Application, First Publication No. 7-247345.

Non-limiting examples of the terpene phenol copolymer, which may be suitably used in the present invention, in terms of its compatibility with the polylactic acid, include the following copolymers (a)-(d):

(a) cyclic terpene-phenol copolymer, prepared by copolymerizing cyclic terpene and phenol;

(b) cyclic terpene/phenol (1:2 molar ratio) addition product, prepared by adding two molecules of phenol to one molecule of cyclic terpene;

(c) polycyclic terpene/phenol (1:2 molar ratio) addition product, prepared by a condensation reaction of the cyclic terpene/phenol (1:2 molar ratio) addition product with aldehydes or ketones; and

(d) polycyclic terpene/phenol (1:1 molar ratio) addition product, prepared by a condensation reaction of the cyclic terpene/phenol (1:1 molar ratio) addition product with aldehydes or ketones.

The terpene phenol copolymer may be in various forms, such as a low molecular weight compound, oligomer, and polymer. Also, it can be a crystalline compound having a melting point or a non-crystalline (amorphous) compound having no melting point.

The cyclic terpene-phenol copolymer described in (a) may be prepared by reacting a cyclic terpene compound with a phenol under the presence of a Friedel-Crafts catalyst.

Also, the cyclic terpene/phenol (1:2 molar ratio) addition product described in (b) may be prepared by reacting a cyclic terpene compound with a phenol under the presence of an acidic catalyst.

Moreover, the polycyclic terpene/phenol (1:2 molar ratio) addition product described in (c) may be prepared by a condensation reaction of the cyclic terpene/phenol (1:2 molar ratio) addition product with aldehydes or ketones.

Furthermore, the polycyclic terpene/phenol (1:1 molar ratio) addition product described in (d) may be prepared by reacting a cyclic terpene with a phenol under the presence of an acidic catalyst to produce a cyclic terpene/phenol (1:1 molar ratio) addition product and subjecting the obtained 1:1 addition product to a condensation reaction with aldehydes or ketones.

These terpene-phenol copolymers may be used solely or in combination with two or more other copolymers.

The terpene compound for preparing the terpene-phenol copolymer used in the present invention may be a monocyclic terpene compound or a bicyclic terpene compound. Non-limiting examples of such compounds include α-pinene, β-pinene, dipentene, limonene, phellandrene, α-terpinen, γ-terpinen, terpinolene, 1,8-cinenole, 1,4-cineole, terpineole, camphene, tricyclene, paramenthene-1, paramenthene-2, paramenthene-3, paramentadiene, and carene.

On the other hand, non-limiting examples of the phenol material for preparing the terpene-phenol copolymer used in the present invention include: phenol, o-cresol, m-cresol, p-cresol, o-ethylphenol, m-ethylphenol, p-ethylphenol, o-butylphenol, m-butylphenol, p-butylphenol, 2,3-xylenol, 2,4-xylenol, 2,5-xylenol, 2,6-xylenol, 3, 4-xylenol, 3,6-xylenol, p-phenylphenol, p-methoxyphenol, m-methoxyphenol, bisphenol-A, bisphenol-F, catechol, resorcinol, hydroquinone, and naphthol. These compounds may be used solely or in combination.

The copolymerization reaction of a cyclic terpene with a phenol to produce the cyclic terpene-phenol copolymer described in (a) above uses about 0.1-12 mol, preferably about 0.2-6 mole, of phenol with respect to one mole of cyclic terpene and subjects the mixture to a reaction at about 0-120° C. for about 1-10 hours under the presence of a Friedel-Crafts catalyst. Examples of the Friedel-Crafts catalysts that may be employed include aluminum chloride and boron trifluoride or complex thereof. A reaction solvent such as an aromatic hydrocarbon is generally used. Examples of commercially available cyclic terpene/phenol copolymer prepared as above include “YS polystar-T-130”, “YS polystar-S-145”, “Mighty Ace G-150” and “Mighty Ace K-125” produced by Yasuhara Chemical Co. Ltd.

The addition reaction of one mole of a cyclic terpene with two moles of a phenol described in (b) above uses about 2-12 mol, preferably about 2-8 mol, of phenol with respect to one mole of cyclic terpene and subjects the mixture to a reaction at about 20-150° C. for about 1-10 hours under the presence of an acidic catalyst. Examples of such acidic catalyst include hydrochloric acid, sulfuric acid, phosphoric acid, polyphosphoric acid, boron trifluoride or complex thereof, cation-exchange resin, and activated clay. Although a reaction solvent need not be used, a solvent such as an aromatic hydrocarbon, alcohol, and ether may be utilized. Examples of a commercially available cyclic terpene/phenol (1:2 mol) addition product prepared as above include “YP-90” by Yasuhara Chemical Co. Ltd.

Examples of the aldehydes or ketones used as a condensation agent to prepare the polycyclic terpene/phenol (1:2 mol) addition product described in (c) include: formaldehyde, paraformaldehyde, acetoaldehyde, propylaldehyde, benzaldehyde, hydroxybenzaldehyde, phenylacetoaldehyde, furfural, acetone, and cyclohexanone.

It is possible to add other phenols together with the cyclic terpene/phenol (1:2 molar ratio) addition product to carry out the condensation reaction. In such a case, the amount of the cyclic terpene/phenol (1:2 molar ratio) addition product is at least about 20% by weight, preferably 40% by weight, with respect to the total amount with the other phenol. If the ratio of the cyclic terpene/phenol (1:2) addition product is lower, a suitable polycyclic terpene/phenol (1:2) addition product may not be obtained.

The ratio of aldehyde or ketone with respect to the cyclic terpene/phenol (1:2) addition product and other phenols in the condensation reaction is about 0.1-2.0 mol, preferably 0.2-1.2 mol, and subjected to a reaction at about 40-200° C. for about 1-12 hours under the presence of an acidic catalyst. If the amount of the aldehyde or ketone is too large, the molecular weight of the resulting polycyclic terpene/phenol (1:2) addition product also becomes too large.

Examples of the acidic catalyst which may be used in the condensation reaction include: inorganic acids, such as hydrochloric acid, nitric acid, and sulfuric acid; and organic acids, such as formic acid, acetic acid, oxalic acid, and toluene sulfonic acid. The amount of the acidic catalyst used is 0.1-5 parts by weight with respect to 100 parts by weight of the cyclic terpene/phenol (1:2) addition product and other phenol. In the condensation reaction, an inert solvent such as aromatic hydrocarbons, alcohols, and ethers may be used.

In the addition reaction of one molecule of a cyclic terpene to one molecule of a phenol to prepare the cyclic terpene/phenol (1:1) addition product which is a precursor of the polycyclic terpene/phenol (1:1) addition product described in (d) above, 0.5-6 mol, preferably 1-4 mol, of phenol is used relative to 1 mol of cyclic terpene, and the rection is carried out at about 20-150° C. for about 1-10 hours under the presence of an acidic catalyst. Examples of such an acidic catalyst include hydrochloric acid, sulfuric acid, phosphoric acid, polyphosphoric acid, boron trifluoride or complex thereof, a cation-exchange resin, and an activated clay. Although a reaction solvent need not be used, solvent such as an aromatic hydrocarbon, alcohol, and ether may be utilized. Examples of a commercially available cyclic terpene/phenol (1:1) addition product prepared as above include “YP-90LL” by Yasuhara Chemical Co. Ltd.

The condensation reaction of the cyclic terpene/phenol (1:1) addition product with aldehydes or ketones to prepare the polycyclic terpene/phenol (1:1) addition product is carried out in the same manner as described in (c) above for the preparation of the polycyclic terpene/phenol (1:2) addition product. Examples of such commercially available products include “DLN-120” and “DLN-140” by Yasuhara Chemical Co. Ltd.

The toner for electrophotography according to the present invention includes a blend of the polylactic acid type resin and the terpene-phenol copolymer as a binder resin component. The ratio of the polylactic acid type resin with respect to the terpene-phenol copolymer (i.e., blend ratio) may be changed within the range between about 80:20 and 20:80 in weight ratio. If the amount of the polylactic acid type resin exceeds the above-mentioned limit, the strength of the melt-kneaded material becomes too strong and a pulverization thereof becomes difficult to carry out. Also, since crystals of the polylactic acid type resin remains in the blend, the thermal flowability decreases in the temperature range below the melting point of the crystals, and there is a danger that the low temperature fixing property becomes insufficient. On the other hand, if the amount of the terpene-phenol copolymer exceeds the above-mentioned limit, the resulting toner becomes too fragile and there is a danger that the developing property of the toner including its durability, are deteriorated. Also, the biodegradability of the toner decreases. The ratio of the polylactic acid type resin and the terpene-phenol copolymer, in order to obtain both high productivity and quality of the product, is preferably between about 50:50 and 30:70.

The method for compounding the terpene-phenol copolymer resin to the polylactic acid type resin is not particularly limited. For instance, they may be mixed using a rolling mill, a Bunbary mixer, or a Super mixer, and may be kneaded using an uniaxial or biaxial extruder. The mixing-kneading process is generally carried out at the temperature in the range between about 120 and 220° C. Note that conventional resins which have been used for toners may be added with an amount which does not impair the properties of the toner for electrophotography according to an embodiment of the present invention.

Examples of the wax, which is a releasing agent, used in the present invention include, for instance, polyolefin type waxes, such as polyethylene wax and polypropylene wax; synthesized waxes, such as Fischer-Tropsch wax; petroleum waxes, such as paraffin wax and micro wax; carnauba wax, candelilla wax, rice wax, and hardened castor oil. Also, it is possible to use denatured wax in order to control fine dispersion of the wax in the resin.

It is preferable that the toner according to an embodiment of the present invention contains at least one kind of wax in a total amount of 7.0-20.0% by weight with respect to the weight of the toner particles. Although one or plural kinds of waxes may be added, it is preferable that at least one kind of them contains lactide as its component. It is also preferable that the wax is finely dispersed in the binder resin in order to prevent problems, such as filming caused by the wax. From this point of view, the wax containing lactide as its component is suitable to be dispersed in the polylactic acid type resin. An example of the wax which contains lactide as its component is carnauba wax. In the toner using a sharp melt type binder resin for the purpose of improving the low temperature fixing property, it becomes difficult to acquire non-offset temperature range of practical level due to insufficient releasing effect if the total weight of the wax is less than 7.0% by weight, and filming due to the wax tends to be easily caused if the total weight of the wax exceeds 20.0% by weight.

Also, it is necessary that at least one kind of the waxes has a melting point (Mp), i.e., an endothermic peak measured by a differential scanning calorimetry (DSC), equal to or less than the softening temperature (Tm) of the terpene-phenol copolymer resin. If the melting point of all of the waxes are higher than the softening temperature of the terpene-phenol copolymer resin, the effect of preventing a low temperature offset decreases, and the low temperature fixing property is deteriorated.

Moreover, it is preferable that at least one kind of the waxes used in the present invention has a melting point of 70-100° C., and the penetration of equal to or less than one. If the melting point is less than 70° C., the preservability of the toner decreases, and if the melting point exceeds 100° C., the low temperature fixing property cannot be sufficiently exerted. Furthermore, it is preferable to combine at least two kinds of the waxes so that both the acquirement of low temperature fixing property and the increase in non-offset temperature range can be easily achieved, and that the dispersibility of the wax components also can be controlled.

In general, a colorant is included in the toner for electrophotography according to an embodiment of the present invention. Also, a charge control agent, etc., may be added to the toner, if necessary, and additives such as a fluidizing agent may be adhered thereto.

Examples of the colorant include the followings.

First, examples of a black pigment include carbon black, activated carbon, and a magnetics of low magnetic force.

Examples of magenta pigment include C. I. Pigment red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, , 68, 81, 83, 87, 88, 89, 90, 112, 114, 122, 123, 163, 202, 206, 207, and 209, C. I. Pigment violet 19, and C. I. Vatred 1, 2, 10, 13, 15, 23, 29, and 35.

Examples of cyan pigment include C. I. Pigment blue 2, 3, 15, 16, and 17, C.I. Vatblue 6, and C. I. Acidblue 45.

Examples of yellow pigment include C. I. Pigment yellow 1, 2, 3, 4, 5, 6, 7, 10, 11, 12, 13, 14, 15, 16, 17, 23, 65, 73, 74, 83, 97, 155, and 180.

These colorants may be used alone or in mixture of two or more. It is necessary that a sufficient amount of the colorants is contained in order to form a visible image of satisfactory density. The colorants may be contained in the amount of 1-15 parts by weight, for example, with respect to 100 parts by weight of the binder resin.

Also, the charge control agent may be added to impart polarity, and the charge control agent may be classified as an agent for positively charged toner and an agent for negatively charged toner.

Examples of the agent for positively charged toner include nigrosine dye, quaternary ammonium salt, cation denatured resin type charge control agent, pyridinium salt and azine.

Examples of the agent for negatively charged toner include azo type metal complex, salicylate metal complex, boron complex, and anion denatured resin type charge control agent.

It is preferable that the charge control agent may be added in the amount of 0.1-5 parts by weight with respect to 100 parts by weight of the binder resin. Zinc complex, chromium complex, boron complex, quaternary ammonium salt, denatured resin type charge control agent, etc., which are white or off-white, may be suitable used for a color toner. These agents may be used singularly or in mixture.

Examples of the additives which may be added to the toner, if necessary, include a magnetic powder, etc.

Examples of the magnetic powder include ferrite powder, magnetite powder, and iron powder. As the ferrite powder, a sintered mixture of MeO—Fe₂O₃ may be used where Me is Mn, Zn, Ni, Ba, Co, Cu, Li Mg, Cr, Ca, V, etc., or a mixture thereof. Also, as the magnetite powder, a sintered mixture of FeO—Fe₂O₃ may be used. It is preferable that the size of the magnetic powder may be in the range of 0.05-3 μm, and that the ratio thereof with respect to the toner be equal to or lower than 70% by weight.

It is possible to add (or adhere) fine powder of hydrophobic silica, if necessary, to the toner for electrophotography according to an embodiment of the present invention. Also, besides the hydrophobic silica, additives, such as magnetic powder, alumina, talc, clay, calcium carbonate, magnesium carbonate, titanium oxide, and fine particles of various resin, may be adhered in order to control the fluidity, charging property, cleaning property, preservability, etc., of the toner.

In order to adhere the above-mentioned fine particles to the toner powder, they may be mixed and agitated using general mixers, such as a turbine type agitator, a Henschel mixer, and a Super mixer.

Also, it is possible to add, if necessary, various additives to the toner for electrophotography according an embodiment of the present invention, such as a known plasticizer, an antioxidant, a thermostabilizer, a photostabilizer, an ultraviolet ray absorbent, a pigment, various fillers, a charge control agent, a flavor, a lubricant, a flame retardant, a foaming agent, an antibacterial-antifungal agent, and other agents.

The toner for electrophotography according to an embodiment of the present invention may be produced by mixing the above-mentioned materials in a predetermined ratio, and melt-kneading, pulverizing, and classifying the mixture. Also, it is possible to add materials other than the binder resin to raw material of the resin in advance when the binder resin is synthesized so that the mixture which becomes a raw material of the toner may be obtained at the same time when the resin is synthesized. Moreover, it is possible to prepare toner particle using a polymerization method.

The toner for electrophotography according to an embodiment of the present invention may be applied to all developing methods including the two-component developing method, the magnetic one-component developing method, and non-magnetic one-component developing method.

Since the toner for electrophotography according to an embodiment of the present invention uses the polylactic acid type resin as a binder resin, it is easily biodegraded and does not cause environmental pollution if discarded to be landfilled. Also, since the toner for electrophotography of the present invention may be easily hydrolyzed using an alkali solution, a deinking process for copied paper can be easily performed and the copied paper may be readily used as a raw material for recycle paper.

The effects of the toner for electrophotography of the present invention from the viewpoint of protecting environment will be explained further in detail. The polylactic acid type resin under natural environment is decomposed by hydrolysis to molecules of low molecular weight, and then further decomposed to water and carbon dioxide by the act of enzymes present in microorganisms. The water and carbon dioxide is photosynthesized to starch by plants. If the starch is subjected to lactic acid fermentation, lactic acid, which is a raw material of the polylactic acid resin, is obtained. That is, the toner for electrophotography of the present invention uses a regenerable resource as its raw material. On the other hand, a polyester resin or a styrene-acryl resin uses limited resources, such as coal and oil, and it is very difficult to biodegrade such resins. Also, carbon dioxide is unilaterally emitted in the air by the incineration of such resins. Moreover, the heat of combustion of the polylactic acid is the same level as that of paper, and hence, there is no danger to damage a combustion furnace. Furthermore, the amount of carbon dioxide generated by combustion is smaller as compared with other general plastics. In addition, in the toner for electrophotography according to an embodiment of the present invention, it becomes possible to introduce the terpene-phenol copolymer resin, whose resin strength is not high but which is effective for obtaining the low temperature fixing property of the toner, by utilizing the strength of the polylactic acid type resin, and hence, excellent low temperature fixing property can be acquired without impairing the durability of the toner. Also, the polylactic acid type resin and the terpene-phenol copolymer resin do not generate volatile gases which are hazardous to human body when thermally fixed.

The transparency of the polylactic acid type resin and the terpene-phenol copolymer resin is higher than the ordinary polyester, and hence, they may be suitably applied to a toner for full-color printing which requires high transparency.

Also, it is preferable that the polylactic acid type resin contains one of the L-lactic acid units and the D-lactic acid units in an amount between 85 mol % and 100 mol % with respect to the total lactic acid units since the fixing strength of the toner obtained becomes high. Moreover, the above-mentioned polylactic acid type resin has excellent thermal flowability at low temperature range, and an image obtained by using the resin has a smooth surface and high gloss.

Furthermore, in the toner for electrophotography of the present invention, since the polylactic acid type resin and the terpene-phenol copolymer resin are used as a binder resin, a filming phenomenon is difficult to occur even if a large amount of wax is added to the toner. Accordingly, it becomes possible to add 7.0% by weight or more of wax to the toner to retain non-offset temperature range of practical level, to prevent the generation of BS on a photosensitive member and fusing to developing members, and to correspond to an oilless fixing system. In addition, since the melting point of at least one kind of the waxes is equal to or less than the softening point of the terpene-phenol copolymer resin, the toner of the present invention has an excellent effect of preventing offset at low temperatures.

Also, since the toner for electrophotography according to an embodiment of the present invention has an excellent dispersed state of the wax, a filming phenomenon is not easily generated, and the charging property thereof is stabilized. Accordingly, sufficient image density, etc., can be maintained under any environmental condition for a long period of time even in a continuous copying of large number of sheets.

Examples:

Hereinafter, the present invention will be described using examples. However, these examples are used only for explanation purposes and are not by any means to restrict the invention.

First, the following toners A-M were prepared. Note that in the following Mw indicates a weight average molecular weight, Mn indicates a number average molecular weight, Tg indicates a glass transition temperature, Ti indicates a melt initial temperature, Tm indicates a softening temperature, and Mp indicates an endothermic peak measured by a differential scanning calorimetry (DSC).

### EXAMPLE 1

Preparation of Toner A

| | |
|---|---|
| Polylactic acid type resin A | 32.4 wt % |
| Molecular weight: Mw = 125,000 | |
| Mn = 57,000 | |
| Tg: 53.2° C. | |
| Ti: 153° C. | |
| Tm: 170° C. | |
| L/D molar ratio: L (mol %)/D (mol %) = | |
| 91.8 (mol %)/8.2 (mol %) | |
| Terpene-phenol copolymer resin A | 48.6 wt % |
| (Cyclic terpene-phenol copolymer | |
| “Mighty Ace K-125”, a product of Yasuhara | |
| Chemical Co. Ltd.) | |
| Molecular weight: Mw = 600 | |
| Tg: 69.5° C. | |
| Melting point (Mp): 82° C. | |
| Ti: 92° C. | |
| Tm: 111° C. | |
| (Polylactic acid type resin A: Terpene-phenol copolymer | |
| resin A = 40:60) | |
| Carbon Black | 7.0 wt % |
| (“MA-100”, a product of Mitsubishi | |
| Chemical Corporation.) | |
| Natural wax | 10.0 wt % |
| (“Camauba #1 Powder”, a product of S. Kato & Co.) | |
| Melting point (Mp): 82° C. | |
| Penetration degree: ≦1 | |
| Iron containing metallic dye | 2.0 wt % |
| (“T-77”, a product of Hodogaya | |
| Chemical Co., Ltd.) | |

The weight average molecular weight (Mw) and the number average molecular weight (Mn) were measured using a gel permeation chromatography (GPC) method. Method for Measuring Melting Point (MP) (an endothermic peak measured by DSC)

Measuring device: Differential scanning calorimetry (DSC)“SSC-5200”, a product of Seiko Instruments Inc.

Measuring method:

A sample of about 10 mg was weighed and put into an aluminum cell. The cell was put onto the above-mentioned measuring device and N₂ gas was blown into the cell at a rate of 50 ml/min. The temperature of the sample was increased from 20 to 150° C. at a rate of 10° C./min, and then rapidly reduced from 150 to 20° C. This process was repeated for twice, and the temperature corresponding to the endothermic peak obtained in the second process was determined to be the melting temperature. Method for Measuring Melt Initial Temperature (Ti) and Softening Temperature (Tm)

The term “melt initial temperature” means a temperature at which a plunger starts to fall when a measurement is carried out using the following measuring device and measuring conditions. The term“softening temperature” means a temperature at a middle point of the moving distance of the plunger from the start to the end of the fall of the plunger.

Measuring device: capillary rheometer (constant pressure extrusion system using weight)“CFT-500”, a product of Shimadzu Corporation

Measuring conditions:

| | |
|---|---|
| Plunger: | 1 cm² |
| Diameter of die: | 1 mm |
| Length of die: | 1 mm |
| Load: | 20 KgF |
| Preheating temperature: | 50-80° C. |
| Preheating time | 300 sec |
| Temperature increasing rate | 6° C./min |

The raw material having the above-mentioned compositional ratio were mixed using a Super mixer and, after being subjected to a heat melt kneading process using a biaxial extruder, the mixture was subjected to a pulverization process using a jet mill and subsequently to a classification process using a dry airflow classifier to obtain toner powder having a volume average particle size of 9 μm.

After this, 1.0% by weight of hydrophobic silica (“TS-530”, a product of Nippon Aerosil Co., Ltd. volume average particle size of about 0.007 μm) was added to the toner powder, and the mixture was mixed using a Henschel mixer at a circumferential rate of 40 m/sec for four minutes to produce the toner A of the present invention.

### EXAMPLE 2

Preparation of Toner B

The toner B of the present invention was obtained using the same procedure as in Example 1 above except that the amount of the polylactic acid resin A, the terpene-phenol copolymer resin A, and the carnauba wax were changed to 28.4, 42.6, and 20% by weight, respectively.

### EXAMPLE 3

Preparation of Toner C

The toner C of the present invention was obtained using the same procedure as in Example 1 above except that the ratio of the polylactic acid resin A and the terpene-phenol copolymer resin A was changed to 30:70 in weight (i.e., 24.3% by weight of the polylactic acid type resin A, and 56.7% by weight of the terpene-phenol copolymer).

### EXAMPLE 4

Preparation of Toner D

The toner D of the present invention was obtained using the same procedure as in Example 1 above except that the wax component was changed to 5% by weight of carnauba wax and 5% by weight of polypropylene wax (“Viscol 660p”, a product of Sanyo Chemical Industries, Ltd., Mp: 135° C.)

### EXAMPLE 5

Preparation of Toner E

| | |
|---|---|
| Polylactic acid type resin A | 30.0 wt % |
| Terpene-phenol copolymer resin A | 44.7 wt % |
| (Cyclic terpene-phenol copolymer “Mighty Ace K-125”, | |
| a product of Yasuhara Chemical Co. Ltd.) | |
| (Polylactic acid type resin A: | |
| Terpene-phenol copolymer resin A = 40:60) | |
| Magenta pigment master batch | 13.3 wt % |
| (Resin: polylactic acid type resin A, Pigment: | |
| “Toner Magenta E02”, a product of | |
| Clariant (Japan) K. K.) | |

The master batch was prepare by heating and dispersing 70% by weight of the polylactic acid type resin A and 30% by weight of Toner Magenta E02 using two-roll dispersing device.

| | |
|---|---|
| Natural wax | 10.0 wt % |
| (“Carnauba #1 Powder”, a product of S. Kato & Co.) | |
| Boron complex salt | 2.0 wt % |
| (“LR-147”, a product of Japan Carlit Co., Ltd.) | |

### EXAMPLE 6

Preparation of Toner F

The toner F of the present invention was obtained using the same procedure as in Example 5 above except that the amount of the polylactic acid resin A, the terpene-phenol copolymer resin A, and the carnauba wax were changed to 25.9, 38.8, and 20% by weight, respectively.

### EXAMPLE 7

Preparation of Toner G

The toner G of the present invention was obtained using the same procedure as in Example 5 above except that the ratio of the polylactic acid resin A and the terpene-phenol copolymer resin A was changed to 30:70 in weight (i.e., 22.4% by weight of the polylactic acid type resin A, and 52.3% by weight of the terpene-phenol copolymer).

### EXAMPLE 8

Preparation of Toner H

The toner H of the present invention was obtained using the same procedure as in Example 1 above except that the amount of the polylactic acid resin A, the terpene-phenol copolymer resin A, and the carnauba wax were changed to 34.4, 51.6, and 5% by weight, respectively.

### Comparative Example 1

Preparation of Toner I

| | |
|---|---|
| Styrene-acrylate copolymer resin A | 81.0 wt % |
| (Monomer composition: styrene/butyl acrylate) | |
| Molecular weight: Mw = 226,000 | |
| Mn = 3,680 | |
| Tg: 60.4° C. | |
| Ti: 115° C. | |
| Tm: 141° C. | |
| Carbon Black | 7.0 wt % |
| (“MA-100”, a product of Mitsubishi | |
| Chemical Corporation.) | |
| Iron containing metallic dye | 2.0 wt % |
| (“T-77”, a product of Hodogaya | |
| Chemical Co., Ltd.) | |
| Natural wax | 10.0 wt % |
| (“Carnauba #1 Powder”, | |
| a product of S. Kato & Co.) | |

The toner I of Comparative Example 1 was obtained from the above materials using the same procedure as in Example 1.

### Comparative Example 2

Preparation of Toner J

| | |
|---|---|
| Polyester resin A | 81.0 wt % |
| (Monomer composition: terephthalic acid/ | |
| trimellitic acid/ethylene glycol/bisphenol-A | |
| (BO)/bisphenol-A (PO)) | |
| Molecular weight: Mw = 71,100 | |
| Mn = 3,430 | |
| Tg: 60.8° C. | |
| Ti: 124° C. | |
| Tm: 161° C. | |
| Carbon Black | 7.0 wt % |
| (“MA-100”, a product of | |
| Mitsubishi Chemical Corporation.) | |
| Iron containing metallic dye | 2.0 wt % |
| (“T-77”, a product of Hodogaya Chemical Co., Ltd.) | |
| Natural wax | 10.0 wt % |
| (“Carnauba #1 Powder”, a product of S. Kato & Co.) | |

The toner J of Comparative Example 2 was obtained from the above materials using the same procedure as in Example 1.

### Comparative Example 3

Preparation of Toner K

| | |
|---|---|
| Polylactic acid type resin A | 81.0 wt % |
| Carbon Black | 7.0 wt % |
| (“MA-100”, a product of | |
| Mitsubishi Chemical Corporation.) | |
| Iron containing metallic dye | 2.0 wt % |
| (“T-77”, a product of Hodogaya Chemical Co., Ltd.) | |
| Natural wax | 10.0 wt % |
| (“Carnauba #1 Powder”, a product of S. Kato & Co.) | |

Although attempts were made to obtain the toner K of Comparative Example 3 using the same procedure as in Example 1, the toner could not be obtained due to impossible pulverization.

### Comparative Example 4

Preparation of Toner L

| | |
|---|---|
| Polyester resin B | 74.7 wt % |
| (Monomer composition: tereplithalic acid/trimellitic acid/ | |
| ethylene glycol/bisphenol-A (EO)/bisphenol-A (P0)) | |
| Molecular weight: Mw = 9,800 | |
| Mn = 3,230 | |
| Tg: 61.8° C. | |
| Ti: 93° C. | |
| Tm: 110° C. | |
| Magenta pigment master batch | 13.3 wt % |
| (Resin: polyester resin B (70 wt %), Pigment: “Toner | |
| Magenta E02”, a product of Clariant (Japan) | |
| K. K. (30 wt %), preparation method | |
| was the same as in Example 5) | |
| Natural wax | 10.0 wt % |
| (“Carnauba #1 Powder”, a product of S. Kato & Co.) | |
| Boron complex salt | 2.0 wt % |
| (“LR-147”, a product of Japan Carlit Co., Ltd.) | |

The toner L of Comparative Example 4 was obtained from the above materials using the same procedure as in Example 1.

### Comparative Example 5

Preparation of Toner M

The toner M of the comparison example 5 was obtained using the same procedure as in Example 1 above except that the natural wax (“Carnauba #1 Powder”, a product of S. Kato & Co.) was changed to a polypropylene wax (“Viscol 550p”, a product of Sanyo Chemical Industries, Ltd., Mp: 139° C., penetration: ≦1). Evaluation of Toners

Following evaluations were made for each of the toners of Examples 1-8, and Comparative Examples of 1-5 obtained as explained above. Results are tabulated in Table 1.

1. Non-offset Temperature Range:

A non-fixed image was obtained on a transfer paper using a two-component copying machine from which a fixing unit had been taken off, and the presence of offset was visually confirmed for the case where the non-fixed image was fixed at a processing speed of 200 mm/sec using a fixing unit of a full-color printer (“MICROLINE 3020C”, a product of Oki Electric Industry Co., Ltd.) as an external fixing device when the temperature of a heat roller was change by 5° C. in the range of 130-210° C.

2. Fixing Strength:

A solid image was copied onto a transfer paper by setting the temperature of a heat fixing roller of the full-color printer (“MICROLINE 3020C”, a product of Oki Electric Industry Co., Ltd.) at 165° C. The copied solid image was folded and then returned to an original state. After this, the solid image was reciprocally rub three times using a weight having a load of 25 g/cm² per unit area and a bottom surface area of 20 cm², which was wrapped with gauze, to obtain the remaining percentage of the toner based on the ratio of image density (ID) after the treatment to the ID prior to be folded. The measurements were performed three times, and an average value thereof was calculated. The same tests were conducted for the cases where the temperature of the heat fixing roller was set at 175 and 185° C. 3. Glossiness:

A solid image, in which an amount of a magenta toner adhered was adjusted to be about 1.0 mg/cm² using the two-component copying machine from which the fixing unit was taken out, was copied onto a transfer paper. Then, the solid image was fixed using an external fixing device of oilless fixing system whose heat fixing roller was set at 165° C. The glossiness of the solid image was measured using a gloss meter (“VGS-SENSOR”, a product of Nippon Denshoku Industries, Ltd.). Note that the glossiness was obtained by measuring 75° specular glossiness. Also, the measurements were performed three times, and an average value thereof was calculated. The same tests were conducted for the cases where the temperature of the heat fixing roller was set at 175 and 185° C.

Moreover, the toner obtained was introduced into a developing device of the full-color printer (“MICROLINE 3020C”, a product of Oki Electric Industry Co., Ltd.), and an A4 paper whose image ratio was 5% was copied onto 10,000 sheets of A4 transfer paper. Then, the following evaluation was made for the transfer paper of initial copying stage and for the transfer paper obtained after the 10,000 sheets copying process. The evaluation was made under the condition of ordinary temperature and humidity (N/N: 20° C., 58%RH). Results are tabulated in Table 1.

4. Image Density (ID)

The image density of the solid image was measured using a MacBeth reflection densitometer “RD-914” (a product of Aretag MacBeth LLC).

5. Background Fogging (BG)

The degree of whiteness of a non-image portion was measured using a color meter (“ZE2000”, a product of Nippon Denshoku Industries, Ltd.), and the results are shown in Table 1 as the difference of whiteness between prior to and after the printing process.

6. Fusing Blackspots (BS)

The photosensitive member and the development roller layer control blade were visually examined. In Table 1, ◯ indicates that no generation of fusing and BS on the photosensitive member was observed, Δ indicates that the generation of streak was observed on the development roller or the generation of slight BS was observed on the photosensitive member, and indicates that defect due to fusing or BS was observed on the image.

TABLE 1

| | | Non-offset | Fixing strength (%) | | | Glossiness | | | Initial | | After 10,000 sheets | | |
|---|---|---|---|---|---|---|---|---|---|---|---|---|---|
| | Toner | width (° C.) | 165° C. | 175° C. | 185° C. | 165° C. | 175° C. | 185° C. | ID | BG | ID | BG | Fusing · BS |
| Ex.1 | A | 150-190 | 64.7 | 73.5 | 80.5 | — | — | — | 1.62 | 0.32 | 1.65 | 0.41 | ◯ |
| Ex.2 | B | 140-190 | 67.9 | 78.4 | 85.3 | — | — | — | 1.73 | 0.38 | 1.75 | 0.44 | Δ |
| Ex.3 | C | 145-190 | 65.3 | 76.7 | 83.6 | — | — | — | 1.67 | 0.33 | 1.66 | 0.40 | Δ |
| Ex.4 | D | 150-195 | 64.5 | 72.1 | 79.9 | — | — | — | 1.60 | 0.37 | 1.61 | 0.38 | ◯ |
| Ex.5 | E | 150-190 | 64.9 | 72.2 | 79.8 | 28.8 | 32.9 | 36.5 | 1.65 | 0.28 | 1.66 | 0.31 | ◯ |
| Ex.6 | F | 140-190 | 66.4 | 77.5 | 84.7 | 30.3 | 35.1 | 39.4 | 1.75 | 0.44 | 1.77 | 0.47 | Δ |
| Fx.7 | G | 145-190 | 65.8 | 77.1 | 84.1 | 29.9 | 34.5 | 38.2 | 1.68 | 0.39 | 1.67 | 0.39 | Δ |
| Ex.8 | H | 150-190 | 63.8 | 71.4 | 78.5 | — | — | — | 1.58 | 0.38 | 1.56 | 0.41 | ◯ |
| C. Ex.1 | I | 155-190 | 50.3 | 61.1 | 69.9 | — | — | — | 1.65 | 0.33 | Fusion caused after 3,000 | | |
| C. Ex.2 | J | 150-190 | 57.2 | 68.5 | 74.3 | — | — | — | 1.72 | 0.42 | 1.69 | 0.75 | X |
| C. Ex.3 | K | Could not | — | — | — | — | — | — | — | — | — | — | — |
| | | pulverized | | | | | | | | | | | |
| C. Ex.4 | L | 150-190 | 55.1 | 68.7 | 73.9 | 27.7 | 31.2 | 34.4 | 1.66 | 0.35 | 1.68 | 0.38 | X |
| C. Ex.5 | M | 165-200 | 47.2 | 56.8 | 69.5 | — | — | — | 1.49 | 0.36 | 1.45 | 0.45 | ◯ |

As is obvious from Table 1, the toners of the present invention of Examples 1-7, at the initial printing stage and after 10,000 sheets printing had the image density of 1.60 or greater and the background fogging of 0.47 or less. Accordingly, a copying process can be carried out without any practical problems, and no offset or generation of BS on a photosensitive member was observed. Also, the toners of the present invention had not problem in terms of its fixing strength and durability, and it was confirmed that an image having excellent glossiness may be obtained. Moreover, the same results were obtained when yellow toner and cyan toner were used, and it was confirmed that the toners of the present invention are also suitable for a full-color toner.

As for the toner of Example 8, although the fixing strength and the image density were somewhat small due to the small amount of the wax added, it had no practical problems.

On the other hand, the toner of Comparative Example 1 had a small fixing strength due to the use of the styrene-acrylate copolymer resin, and fusing was generated after copying 3,000 sheets.

The toner of Comparative Example 2 also had a small fixing strength and somewhat large background fogging after copying 10,000 sheets of paper. Also, fusing and BS were caused.

The toner of Comparative Example 3 could not be pulverized since it did not contain the terpene-phenol copolymer resin.

As for the toner of Comparative Example 4, fusing and BS were generated after copying 10,000 sheets of paper due to the use of the polyester resin.

The toner of Comparative Example 5 had small fixing strength and practical problems since the melting temperature of the wax was higher than the softening temperature of the terpene-phenol copolymer resin.

As explained above, the toner for electrophotography according to an embodiment of the present invention includes a polylactic acid type resin; a terpene-phenol copolymer; and at least one kind of wax, and a melting point of at least one kind of the wax is equal to or less than a softening temperature of the terpene-phenol copolymer. Accordingly, the toner for electrophotography according to an embodiment of the present invention has remarkable effects including the capability of corresponding to an oilless fixing system, being eco-friendly and safe to human body, and is capable of maintaining sufficient image density, etc., for a long period of time under any environmental conditions including a continuous copying of large number of sheets. Also, the toner of the present invention retains a non-offset temperature range of practically applicable level, does not generate BS on a photosensitive member or fusing to a developing member, has excellent low temperature fixing property and durability, exerts gloss, color mixing property, and transparency sufficient for fixing a full-color image, and is capable of forming an image having sufficient optical transparency when used for an OHP film.

Moreover, if the ratio (in weight) of the polylactic acid type resin with respect to the terpene-phenol copolymer resin is in the range between about 80:20 and 20:80, both the low temperature fixing property and the durability can be obtained without causing problems in the productivity and deterioration of the toner.

Furthermore, if at least one kind of the wax contained in the toner includes lactide, it becomes possible to prevent the generation of filming due to the presence of the wax.

Having thus described an exemplary embodiment of the invention, it will be apparent that various alterations, modifications, and improvements will readily occur to those skilled in the art. Such alterations, modifications, and improvements, though not expressly described above, are nonetheless intended and implied to be within the spirit and scope of the invention. Accordingly, the foregoing discussion is intended to be illustrative only: the invention is limited and defined only by the following claims and equivalents thereto.

What is claimed is:

1. A toner for electrophotography, comprising:
a polylactic acid type resin;
a terpene-phenol copolymer; and
at least one kind of wax, wherein
a melting point of at least one kind of said wax is equal to or less than a softening temperature of said terpene-phenol copolymer.

2. A toner for electrophotography according to claim 1, wherein said polylactic acid type resin has a biodegradable property.

3. A toner for electrophotography according to claim 1, wherein
a molar fraction of one of L-lactic acid unit and D-lactic acid unit with respect to a total lactic acid unit in said polylactic acid type resin is in the range between about 85 mol % and about 100 mol %.

4. A toner for electrophotography according to claim 1, wherein
a total amount of said wax is in the range between about 7-20% by weight with respect to toner particles.

5. A toner for electrophotography according to claim 1, wherein
said terpene-phenol copolymer comprises at least one composition selected from the group consisting of:
(a) cyclic terpene-phenol copolymer, prepared by copolymerizing cyclic terpene and phenol;
(b) cyclic terpene/phenol (1:2 molar ratio) addition product, prepared by adding two molecules of phenol to one molecule of cyclic terpene;
(c) polycyclic terpene/phenol (1:2 molar ratio) addition product, prepared by a condensation reaction of a cyclic terpene/phenol (1:2 molar ratio) addition product with aldehydes and ketones; and
(d) polycyclic terpene/phenol (1:1 molar ratio) addition product, prepared by a condensation reaction of a cyclic terpene/phenol (1:1 molar ratio) addition product with aldehydes and ketones.

6. A toner for electrophotography according to claim 1, wherein a weight ratio of said polylactic acid type resin to said terpene-phenol copolymer resin is in the range between about 80:20 and 20:80.

7. A toner for electrophotography according to claim 1, wherein at least one kind of said wax includes lactide as its component.

8. A toner for electrophotography according to claim 1, wherein said toner is a toner for full-color printing corresponding to an oilless fixing system.

9. A toner for electrophotography according to claim 1, wherein
said polylactic acid type resin has a structure expressed by the following formula (I); 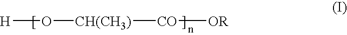
where R is an alkyl group having 1-24 carbon atoms, an alkali metal or an alkali earth metal, and n is an integer between 10 and 20,000.
